(19) United States
(12) Patent Application Publication
(10) Pub. No.: US 2008/0130300 A1
(43) Pub. Date: Jun. 5, 2008

(54) LAMP MODULE

(76) Inventors: Chun-Ping WANG, Hsinchu (TW); Chih-Chung YANG, Hsinchu (TW)

Correspondence Address: OSTROLENK FABER GERB & SOFFEN, 1180 AVENUE OF THE AMERICAS, NEW YORK, NY, 100368403, US

(21) Appl. No.: 11/843,683

(22) Filed: Aug. 23, 2007

(30) Foreign Application Priority Data
Dec. 4, 2006 (TW) 095144952

(51) Int. Cl. F21V 21/088

(52) U.S. Cl. 362/396

(57) ABSTRACT

A lamp module includes a lamp unit, a mounting seat, and a positioning unit. The lamp unit includes a lamp cup having a cup opening, and a lampwick disposed in the lamp cup. The lamp cup further has a flange that extends outwardly from a peripheral edge defining the cup opening. The mounting seat includes front and rear sides, and has a seat hole extending through the front and rear sides, and facing the cup opening. The flange is disposed to abut against the rear side. The positioning unit includes a body portion coupled to the mounting seat, and a plurality of clip portions connected to the body portion and abutting against the lamp cup. The clip portions include at least one first clip portion extending and bending from the body portion into a V shape and having a pressing end which abuts against the flange.

### CROSS-REFERENCE TO RELATED APPLICATION

This application claims priority of Taiwanese Application No. 095144952, filed on Dec. 4, 2006.

### BACKGROUND OF THE INVENTION

1. Field of the Invention

The invention relates to a lamp module, more particularly to a lamp module used in a projector.

2. Description of the Related Art

As shown in FIG. 1 and FIG. 2, a conventional lamp module 1 for a projector includes a lamp unit 11 and a lamp support. The lamp unit 11 includes a lamp cup 111, and a lampwick 112 disposed in the lamp cup 111. The lamp cup 111 is formed with four protrusions 113 extending outwardly and respectively from four corners of a peripheral edge of the lamp cup 111. A rear end of the lampwick 112 extends out of the lamp cup 111 for connecting to a power supply plug (not shown). The lamp support is secured inside the projector (not shown), and includes a mounting seat 12 and a base 10. The lamp unit 11 is secured to the mounting seat 12, and a bottom side of the mounting seat 12 is secured to the base 10. The base 10 is provided with a power socket 100 for connecting the power supply plug thereto.

The mounting seat 12 is substantially rectangular, is formed with a circular seat hole 121 at a center thereof, and has four corners 122. A first one of the four corners 122, i.e., the upper right hand corner 122 in the figures, is defined as a reference corner 122a. Two sides extending from the reference corner 122a are defined as reference sides 123. Each of the reference sides 123 is provided with a plurality of protruding ribs 124 that are spaced apart from each other. The four corners 122 of the mounting seat 12 are respectively provided with a protruding station 125.

Referring to FIG. 1, FIG. 2 and FIG. 3, normally, when the lamp unit 11 to the mounting seat 12 is mounted, it should be kept in mind that a center (B) of the lampwick 112 has to be aligned with an optical center (A) of the mounting seat 12 in order to ensure precision of an optical axis of the lamp module 1. Therefore, a conventional way of mounting the lamp unit 11 to the mounting seat 12 is to fasten a pressing tab 131, 132 at each of the corners 122 except for the reference corner 122a after disposing the lamp unit 11 to abut against the mounting seat 12. The pressing tab 132 fastened to the corner 122b diagonally opposite to the reference corner 122a is in the form of a resilient tab for pressing against an outer surface of the lamp cup 111. The resilient tab not only functions to press the lamp unit 11 toward the mounting seat 12, but also urges the lamp unit 11 toward the reference corner 122a, while pushing edges of the lamp unit 11 to abut against the reference sides 123 of the mounting seat 12. This way, the center (B) of the lamp unit 11 is aligned with the optical center (A) of the mounting seat 12. The other pressing tabs 131 fastened to the corresponding corners 122 press against the protrusions 113 of the lamp cup 111 for pressing the lamp unit 11 toward the mounting seat 12.

With reference to FIG. 1 and FIG. 4, the conventional way of mounting the lamp unit 11 to the mounting seat 12 involves fastening a total of three pressing tabs 131, 132, which is time consuming. In addition, when the protrusions 113 extending from the peripheral edge of the lamp cup 111 are too small in surface area, the pressing effect provided thereby is very limited. Furthermore, the pressing force exerted by the pressing tabs 131 on the corresponding protrusions 113 is controlled by the precision in size correspondence between the protrusions 113 and the pressing tabs 131. Otherwise, if the pressing force exerted by the pressing tabs 131 on the corresponding protrusions 113 is too large, cracking of the lamp cup 111 easily results. On the other hand, if the pressing force exerted by the pressing tabs 131 on the corresponding protrusions 113 is too small, the lamp module 11 easily gets loose such that the center (B) of the lamp module 11 is not aligned with the optical center (A) of the mounting seat 12. Consequently, the optical axis of the lamp module 1 is offset from that desired.

### SUMMARY OF THE INVENTION

Therefore, the object of the present invention is to provide a lamp module, which is easily assembled, whose lamp unit is not easily cracked due to excessive external pressing forces, and whose lamp unit is located precisely so as to ensure precision of an optical axis of the lamp module.

According to the present invention, a lamp module is provided and includes a lamp unit, a mounting seat, and a positioning unit. The lamp unit includes a lamp cup which has a cup opening, and a lampwick which is disposed in the lamp cup. The lamp cup further has a flange extending outwardly from a peripheral edge defining the cup opening. The mounting seat includes a front side, and a rear side disposed opposite to the front side, and has a seat hole extending through the front and rear sides. The lamp cup abuts against the rear side. The cup opening faces the seat hole of the mounting seat. The positioning unit includes a body portion coupled to the rear side of the mounting seat, and a plurality of clip portions connected to the body portion and abutting against the lamp cup of the lamp unit. The plurality of clip portions include at least one first clip portion extending and bending from the body portion into a V shape and having a pressing end which abuts against the flange of the lamp cup when the flange abuts against the rear side of the mounting seat.

Since the present invention utilizes the positioning unit which includes the clip portions, the problems encountered in the prior art, such as difficulties in assembly and in fastening to the mounting seat, are overcome, thereby saving time. In addition, since pressing of the pressing ends of the clip portions on the flange of the lamp cup alone is capable of securing the lamp cup to the mounting seat, it is only necessary for the flange to have a size sufficient for providing contact with the pressing ends. Therefore, both the material used and the cost incurred in manufacturing the lamp module are saved. Further, the junctions between the body portion and the clip portions are resilient such that excessive forces provided by fastening of the screws to the screw holes are absorbed so as to maintain a definite pressing force (F) exerted by the pressing ends on the flange. Not only is the lamp unit secured in place, but the lamp unit is also prevented from cracking due to the excessive forces.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is an assembled perspective view of a conventional lamp module;

FIG. 2 is an exploded perspective view of the conventional lamp module;

FIG. 3 is a rear view of the assembled conventional lamp module;

FIG. 4 is a sectional view of the conventional lamp module taken along line F-F in FIG. 3;

FIG. 5 is an exploded perspective view of the preferred embodiment of a lamp module according to the present invention;

FIG. 6 is an assembled perspective view of the preferred embodiment;

FIG. 7 is a rear view of the assembled preferred embodiment;

FIG. 8 is an enlarged fragmentary sectional view of the preferred embodiment taken along line D-D in FIG. 7; and

FIG. 9 is an enlarged fragmentary sectional view of the preferred embodiment taken along line E-E in FIG. 7.

### DETAILED DESCRIPTION OF THE PREFERRED EMBODIMENT

In the following detailed description of the preferred embodiment, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

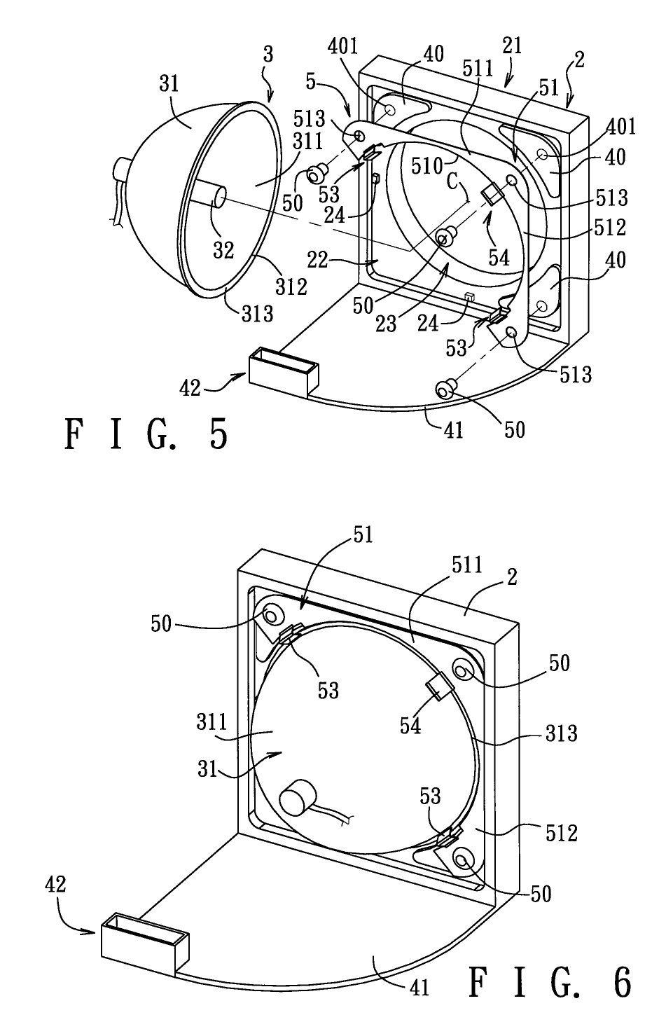

As shown in FIG. 5 and FIG. 6, a preferred embodiment of a lamp module according to the present invention includes a lamp support, a lamp unit 3, and a positioning unit 5. The lamp support permits mounting of the lamp unit 3 inside a projector (not shown). The lamp support includes a mounting seat 2 and a base 41 having the mounting seat 2 mounted thereon. Specifically, a bottom side of the mounting seat 2 is secured to the base 41, and an electric or power socket 42 is disposed on the base 41.

The mounting seat 2 is substantially rectangular, and includes a front side 21, and a rear side 22 disposed opposite to the front side 21 and confronting the electric socket 42, and has a seat hole 23 which extends through the front and rear sides 21, 22. Besides, the seat hole 23 defines an optical center (C). The mounting seat 2 is provided with two positioning protrusions 24 respectively disposed at a left side and a bottom side of the rear side 22 of the mounting seat 2, and acting as reference positioning points for the lamp unit 3.

The lamp unit 3 includes a substantially bowl-shaped lamp cup 31 which has a cup opening 311, and a lampwick 32 disposed in the lamp cup 31. The lamp cup 31 has an annular flange 313 extending outwardly from a peripheral edge 312. The lampwick 32 has one end extending toward a center of the cup opening 311 of the lamp cup 31, and another end extending rearwardly outside the lamp cup 31 and connected to a conducting wire. The conducting wire is connected electrically to the electric socket 42. The cup opening 311 of the lamp cup 31 faces the seat hole 23 of the mounting seat 2, and the lamp cup 31 abuts against the rear side 22 of the mounting seat 2. The seat hole 23 of the mounting seat 2 is designed in accordance with the cup opening 311 of the lamp cup 31. In this embodiment, the seat hole 23 and the cup opening 311 are both circular, and the optical center (C) defined by the seat hole 23 is the center of the circle.

The positioning unit 5 includes a body portion 51, and a plurality of clip portions 53, 54. The positioning unit 5 is a thin metal plate, and the body portion 51 and the clip portions 53, 54 are formed integrally by punching and bending. The body portion 51 is coupled to the rear side 22 of the mounting seat 2 via a plurality of screws 50. The body portion 51 includes a horizontal segment 511 and a vertical segment 512. The body portion 51 is an L-shaped plate, where a first end of the horizontal segment 511 is connected perpendicularly to a third end of the vertical segment 512. Junction of the horizontal segment 511 and the vertical segment 512 corresponds to an upper right corner of the mounting seat 2. The body portion 51 has an inner edge 510, which is defined by the horizontal and vertical segments 511, 512, and which is a substantially C-shaped curved inner edge. Specifically, clip portions 53, 54 are connected to the horizontal and vertical segments 511, 512 at the inner edge 510. A second end of the horizontal segment 511 opposite to the first end, a fourth end of the vertical segment 512 opposite to the third end, and the junction of the horizontal and vertical segments 511, 512 are each formed with a fastening hole 513, which is a circular hole. The mounting seat 2 is provided with three protruding stations 40 disposed at three corners of the mounting seat 2, respectively. The three corners are the upper left corner, the upper right corner, and the lower right corner in this embodiment. Each of the protruding stations 40 is formed with a screw hole 401. Each of the screws 50 extends through a corresponding fastening hole 513 and engages threadedly a corresponding screw hole 401 so as to fasten the positioning unit 5 to the mounting seat 2. At the same time, the flange 313 of the lamp cup 31 is urged by the positioning unit 5 to abut against the positioning protrusions 24 of the mounting seat 2.

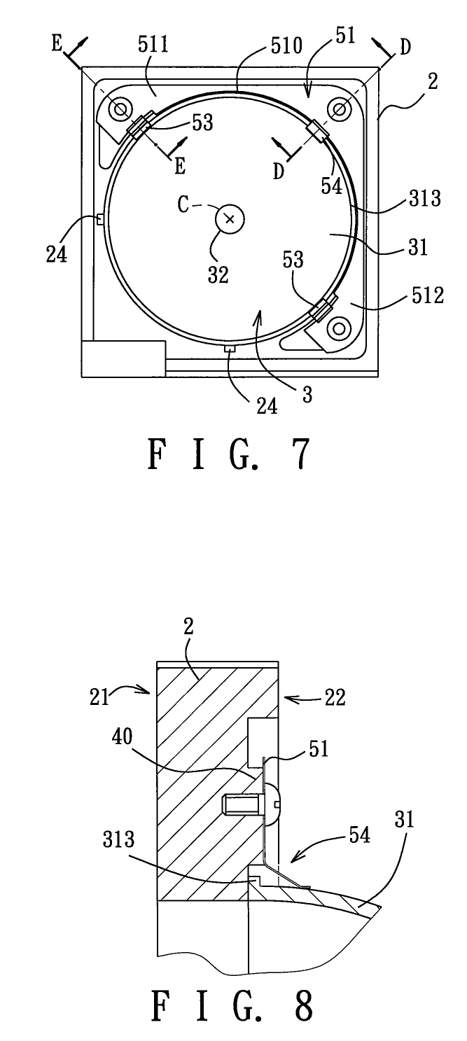

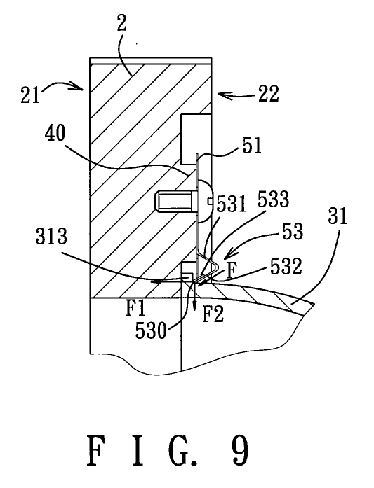

Referring to FIG. 7, FIG. 8 and FIG. 9, in this embodiment, the clip portions 53, 54 are connected to the body portion 51, and abut against the lamp cup 31 of the lamp unit 3. The plurality of clip portions 53, 54 include two first clip portions 53, and a second clip portion 54. The first and second clip portions 53, 54 are connected to the body portion 51, and abut against the lamp cup 31. The second clip portion 54 is disposed such that the second clip portion 54 and one of the first clip portions 53 is aligned along a first direction, and such that the second clip portion 54 and the other one of the first clip portions 53 is aligned along a second direction, which is substantially perpendicular to the first direction. The second clip portion 54 is disposed at a junction of the first end of the horizontal segment 511 and the third end of the vertical segment 512 of the body portion 51 of the positioning unit 5. The second clip portion 54 extends from the inner edge 510 of the body portion 51 toward the optical center (C) defined by the seat hole 23 and away from the mounting seat 2. The two first clip portions 53 are disposed respectively at the second end of the horizontal segment 511 and the fourth end of the vertical segment 512 of the body portion 51. The two first clip portions 53 respectively extend from the inner edge 510 of the body portion 51 toward the optical center (C), and are disposed opposite to each other relative to the optical center (C) defined by the seat hole 23. Each of the first clip portions 53 extends and bends from the body portion 51 into a V shape. One end of each of the first clip portions 53 is connected to the body portion 51, while the other end is a pressing end 530. Each of the first clip portions 53 includes first, second and third segments 531, 532, 533. The first segment 531 is connected to the inner edge 510 of the body portion 51, and extends away from the mounting seat 2 toward the optical center (C) defined by the seat hole 23. The second segment 532 extends from the first segment 531, and bends toward the mounting seat 2 and the optical center (C). The third segment 533 extends from the second segment 532, and bends to overlap the second segment 532 and to confront the first segment 531. In this embodiment, the length of the second segment 532 is greater than that of the first segment 531, and the junction of the second and third segments 532, 533 forms the pressing end 530, which abuts against the annular flange 313 of the lamp cup 31 and has a bent rounded corner.

When the positioning unit 5 is fastened to the mounting seat 2, the second clip portion 54 of the positioning unit 5 abuts against an outer surface of the lamp cup 31. Since the second clip portion 54 is disposed at the upper right corner of the lamp cup 31, and since the positioning protrusions 24 of the mounting seat 2 are respectively disposed at the left side and bottom side of the lamp cup 31, when the second clip portion 54 pushes the lamp cup 31 toward the lower left corner of the mounting seat 2, the lamp cup 31 is urged to abut against the positioning protrusions 24 such that a center of the lampwick 32 is aligned with the optical center (C) defined by the seat hole 23. In other words, the two positioning protrusions 24 are provided as reference positioning points during mounting of the lamp unit 3 to the mounting seat 2 so as to ensure that when the lamp cup 31 abuts against the two positioning protrusions 24, the center of the lampwick 32 is aligned with the optical center (C), thereby preventing offset of an optical axis of the lamp module.

Referring to FIG. 7 and FIG. 9, the pressing ends 530 of the two first clip portions 53 respectively abut against the upper left and lower right sides of the flange 313 of the lamp cup 31. At this time, since each of the first clip portions 53 extends and bends from the body portion 51 into a V shape, and since only the pressing ends 530 abut against the flange 313 of the lamp cup 31 (as shown in FIG. 9), even if the force of fastening the positioning unit 5 to the mounting seat 2 is too large, the excessive force exerted on the lamp cup 31 is absorbed by the resiliency in the junctions between the first clip portions 53 and the body portion 51 such that a definite pressing force (F) exerted by the pressing end 530 on the flange 313 of the lamp cup 31 is maintained.

Furthermore, referring again to FIG. 9, the pressing force (F) exerted by the pressing end 530 of each of the first clip portions 53 on the flange 313 is decomposed into first and second force components (F1), (F2). The first force component (F1) helps press the lamp cup 31 such that the lamp cup 31 abuts tightly against the mounting seat 2, while the second force component (F2) helps maintain alignment between the center of the lampwick 32 and the optical center (C) defined by the seat hole 23 so as to prevent displacement of the lamp cup 31, which results in the offset of the optical axis of the lamp module.

With the pressing end 530 having the bent rounded corner, the flange 313 of the lamp cup 31 is prevented from cracking when the second segment 532 of the first clip portion 53 abuts against the flange 313 due to a concentrated exertion of force at the tip of the pressing end 530.

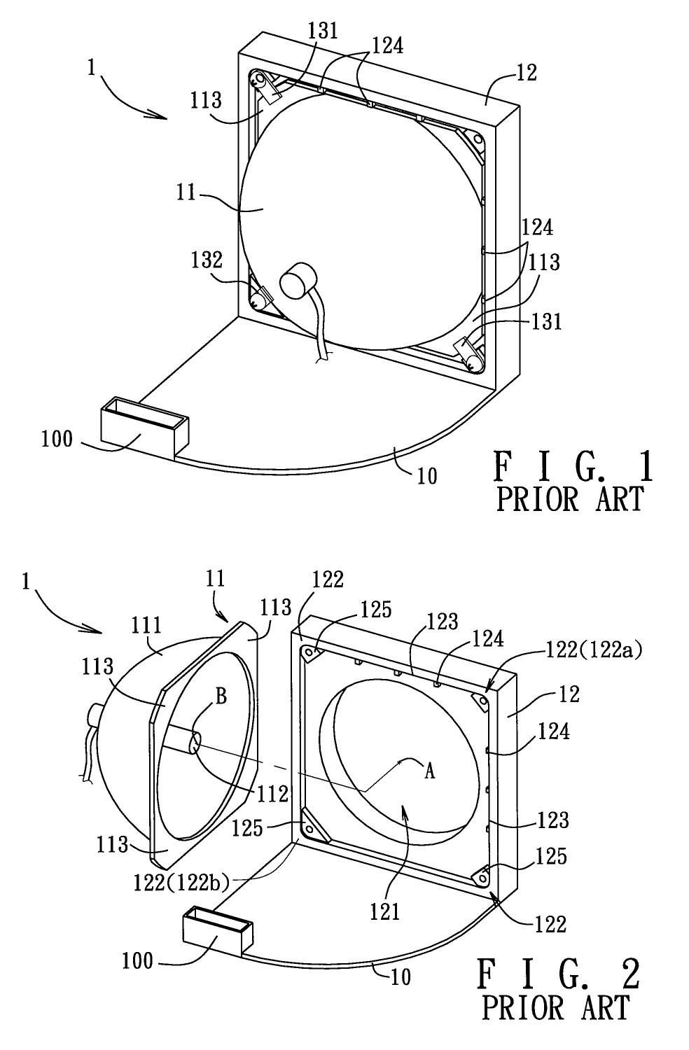

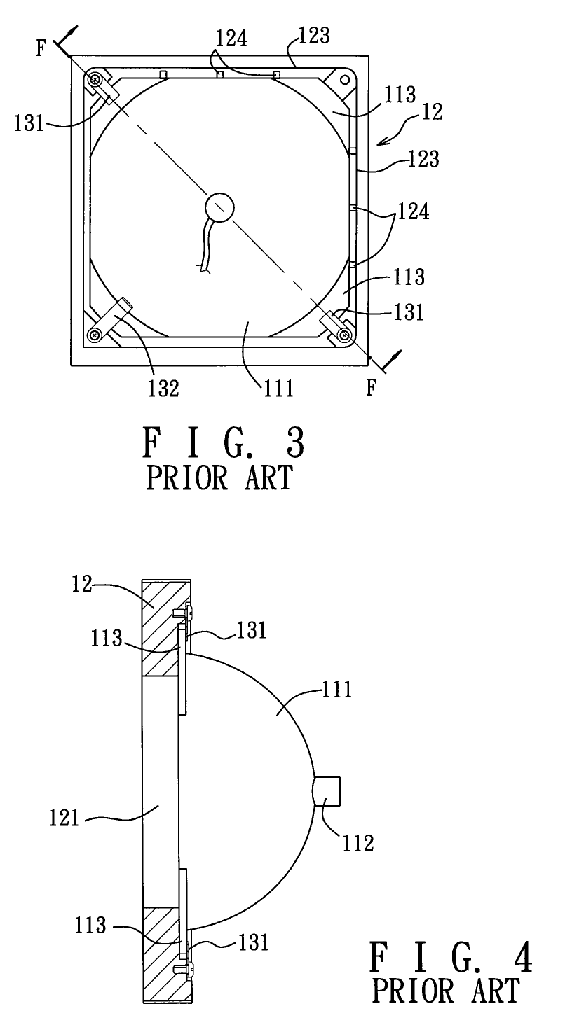

Since the present invention utilizes an integrally formed positioning unit 5, which includes the first and second clip portions 53, 54, to replace the three conventional pressing tabs 131, 132 (as shown in FIG. 1), the problems encountered in the prior art, such as difficulty in assembly and in fastening to the mounting seat 12, are overcome, thereby saving time. In addition, since pressing of the pressing ends 530 of the first clip portions 53 on the flange 313 of the lamp cup 31 alone is capable of securing the lamp cup 31 to the mounting seat 2, it is only necessary for the flange 313 to have a size sufficient for providing contact with the pressing ends 530. Therefore, as compared to the prior art, where the size of the flange 113 (as shown in FIG. 1) needs to be large enough for the pressing tabs 131, 132 to abut against the protrusions 113 of the lamp cup 111, the size of the flange 313 according to the present invention is much smaller, thereby saving both the material used and the cost incurred in manufacturing the lamp module. Further, it is no longer necessary for the cooperation between the first clip portions 53 and the flange 313 to be as precise and as controlled as in the prior art. Moreover, the junctions between the body portion 51 and the first and second clip portions 53, 54 are resilient such that excessive forces provided by fastening of the screws 50 to the screw holes 401 can be absorbed so as to maintain a definite pressing force (F) exerted by the pressing ends 530 on the flange 313. Not only is the lamp unit 3 secured in place, but the lamp unit 3 is also prevented from cracking due to excessive forces.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A lamp module comprising:
a lamp unit including a lamp cup which has a cup opening, and a lampwick which is disposed in the lamp cup, the lamp cup further having a flange which extends outwardly from a peripheral edge defining the cup opening;
a mounting seat including a front side, and a rear side disposed opposite to the front side, and having a seat hole which extends through the front and rear sides, the lamp cup abutting against the rear side, the cup opening facing the seat hole of the mounting seat; and
a positioning unit including a body portion which is coupled to the rear side of the mounting seat, and a plurality of clip portions which are connected to the body portion and which abut against the lamp cup of the lamp unit, the plurality of clip portions including at least one first clip portion which extends and bends from the body portion into a V shape and which has a pressing end abutting against the flange of the lamp cup when the lamp cup abuts against the rear side of the mounting seat.

2. The lamp module as claimed in claim 1, wherein the positioning unit includes two of the first clip portions disposed opposite to each other relative to an optical center defined by the seat hole.

3. The lamp module as claimed in claim 2, wherein each of the first clip portions includes first, second and third segments, the first segment being connected to the body portion and extending away from the mounting seat toward the optical center defined by the seat hole, the second segment extending from the first segment and bending toward the optical center, the third segment extending from the second segment and bending to overlap the second segment and to confront the first segment, junction of the second and third segments forming the pressing end which abuts against the flange of the lamp cup and which has a bent rounded corner.

4. The lamp module as claimed in claim 1, wherein the body portion of the positioning unit includes a horizontal segment, and a vertical segment extending perpendicularly from the horizontal segment, the horizontal segment cooperating with the vertical segment to define an inner edge, the clip portions being connected to the horizontal and vertical segments at the inner edge.

5. The lamp module as claimed in claim 4, wherein:
the horizontal segment includes opposite first and second ends, the vertical segment including opposite third and fourth ends, the first and third ends being connected to each other;
the positioning unit including two of the first clip portions and a second clip portion, the first clip portions being disposed respectively at the second and fourth ends, the second clip portion being disposed at a junction of the first and third ends.

6. The lamp module as claimed in claim 4, wherein:
the horizontal segment includes opposite first and second ends, the vertical segment including opposite third and fourth ends, the first and third ends being connected to each other;
the body portion being formed with a plurality of fastening holes at the second and fourth ends, and at a junction of the first and third ends, the positioning unit further including a plurality of screws that respectively extend through the fastening holes for fastening the body portion of the positioning unit to the mounting seat.

7. The lamp module as claimed in claim 1, wherein the positioning unit includes two of the first clip portions and a second clip portion, the second clip portion and one of the first clip portions being aligned along a first direction, the second clip portion and the other one of the first clip portions being aligned along a second direction which is substantially perpendicular to the first direction.

8. The lamp module as claimed in claim 1, wherein the clip portions further includes a second clip portion which extends toward an optical center defined by the seat hole and away from the mounting seat, and which abuts against the lamp cup of the lamp unit.

9. The lamp module as claimed in claim 1, further comprising a base having the mounting seat mounted thereon, and an electric socket disposed on the base.
